(19) United States
(12) Patent Application Publication
(10) Pub. No.: US 2024/0070521 A1
(43) Pub. Date: Feb. 29, 2024

(54) LAYER FREEZING & DATA SIEVING FOR SPARSE TRAINING

(71) Applicants: Jian Ren, Hermosa Beach, CA (US); Sergey Tulyakov, Santa Monica, CA (US); Yanyu Li, Malden, MA (US); Geng Yuan, Medford, MA (US)

(72) Inventors: Jian Ren, Hermosa Beach, CA (US); Sergey Tulyakov, Santa Monica, CA (US); Yanyu Li, Malden, MA (US); Geng Yuan, Medford, MA (US)

(21) Appl. No.: 17/893,241

(22) Filed: Aug. 23, 2022

(51) Int. Cl. G06N 20/00; G06K 9/62

(52) U.S. Cl. CPC G06N 20/00; G06K 9/6256

(57) ABSTRACT

A layer freezing and data sieving technique used in a sparse training domain for object recognition, providing end-to-end dataset-efficient training. The layer freezing and data sieving methods are seamlessly incorporated into a sparse training algorithm to form a generic framework. The generic framework consistently outperforms prior approaches and significantly reduces training floating point operations per second (FLOPs) and memory costs while preserving high accuracy. The reduction in training FLOPs comes from three sources: weight sparsity, frozen layers, and a shrunken dataset. The training acceleration depends on different factors, e.g., the support of the sparse computation, layer type and size, and system overhead. The FLOPs reduction from the frozen layers and shrunken dataset leads to higher actual training acceleration than weight sparsity.

### TECHNICAL FIELD

The present subject matter relates to sparse training for deep learning on edge devices to perform object recognition.

### BACKGROUND

Sparse training for object recognition has emerged as a promising paradigm for efficient deep learning on edge devices. Increasing sparsity is not always ideal since it can introduce severe accuracy degradation at high sparsity levels.

### BRIEF DESCRIPTION OF THE DRAWINGS

The drawing figures depict one or more implementations, by way of example only, not by way of limitations. In the figures, like reference numerals refer to the same or similar elements.

Features of the various implementations disclosed will be readily understood from the following detailed description, in which reference is made to the appended drawing figures. A reference numeral is used with each element in the description and throughout the several views of the drawing. When a plurality of similar elements is present, a single reference numeral may be assigned to like elements, with an added letter referring to a specific element.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawing are the following figures:

FIG. 1A is an illustration depicting an overview of a SpFDE framework;

FIG. 1B is a flowchart of a method using the SpFDE framework to train a sparse network;

FIG. 2A is an algorithm for the training flow of the SpFDE framework including progressive layer freezing;

FIG. 2B is a flowchart of a method illustrating the steps of the algorithm shown in FIG. 2A;

FIG. 3A are illustrations depicting different layer freezing schemes;

FIG. 3B are graphs illustrating a trend of layer gradient norm and a difference of layer gradient norm during dynamic sparse training;

FIG. 4 is a flowchart of a data sieving method achieving true dataset-efficient training throughout the sparse training process;

FIG. 5 is a graph illustrating the superior memory saving of the SpFDE framework;

FIG. 6 is a table illustrating a comparison of accuracy and computation FLOPs results on the CIFAR-100 dataset using a residual network (ResNet)-32;

FIG. 7 is a table depicting comparison results on the ImageNet dataset using ResNet-50; and

FIG. 8 is a block diagram of a sample configuration of a computer system adapted to implement the SpFDE framework.

### DETAILED DESCRIPTION

A layer freezing and data sieving technique used in a sparse training domain for object recognition that provides end-to-end dataset-efficient training. The layer freezing and data sieving methods are seamlessly incorporated into a sparse training algorithm to form a generic framework (referred to herein as the “SpFDE framework”). The SpFDE framework consistently outperforms prior approaches and significantly reduces training floating point operations per second (FLOPs) and memory costs while preserving high accuracy. The reduction in training FLOPs comes from three sources: weight sparsity, frozen layers, and a shrunken dataset. The training acceleration depends on different factors, e.g., the support of the sparse computation, layer type and size, and system overhead. The FLOPs reduction from the frozen layers and shrunken dataset leads to higher actual training acceleration than weight sparsity. This makes the layer freezing and data sieving method more valuable in sparse training. Overall computation FLOPs is used to measure the training acceleration, which may be considered a theoretical upper bound.

The following detailed description includes systems, methods, techniques, instruction sequences, and computing machine program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and method described because the relevant teachings can be applied or practice in a variety of ways. The terminology and nomenclature used herein is for the purpose of describing particular aspects only and is not intended to be limiting. In general, well-known instruction instances, protocols, structures, and techniques are not necessarily shown in detail.

The terms “coupled” or “connected” as used herein refer to any logical, optical, physical, or electrical connection, including a link or the like by which the electrical or magnetic signals produced or supplied by one system element are imparted to another coupled or connected system element. Unless described otherwise, coupled or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element that is integrated into or supported by the element.

The term “proximal” is used to describe an item or part of an item that is situated near, adjacent, or next to an object or person; or that is closer relative to other parts of the item, which may be described as “distal.” For example, the end of an item nearest an object may be referred to as the proximal end, whereas the generally opposing end may be referred to as the distal end.

The orientations of device, other mobile devices, associated components and any other devices incorporating a camera, an inertial measurement unit, or both such as shown in any of the drawings, are given by way of example only, for illustration and discussion purposes. In operation, the devices may be oriented in any other direction suitable to the particular application of the devices; for example, up, down, sideways, or any other orientation. Also, to the extent used herein, any directional term, such as front, rear, inward, outward, toward, left, right, lateral, longitudinal, up, down, upper, lower, top, bottom, side, horizontal, vertical, and diagonal are used by way of example only, and are not limiting as to the direction or orientation of any camera or inertial measurement unit as constructed or as otherwise described herein.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Reference now is made in detail to the examples illustrated in the accompanying drawings and discussed below.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Sparse training, as a promising solution for efficient training on edge devices to perform object recognition, has drawn significant attention from both the industry and academia. Recent studies have proposed various sparse training algorithms with computation and memory savings to achieve training acceleration. These sparse training approaches can be divided into two main categories. The first category is fixed-mask sparse training methods, aiming to find a better sparse structure in the initial phase and keep the sparse structure constant throughout the entire training process. These approaches have a straightforward sparse training process but suffer from a higher accuracy degradation. Another category is Dynamic Sparse Training (DST), which usually starts the training from a randomly selected sparse structure. DST methods tend to continuously update the sparse structure during the sparse training process while maintaining an overall sparsity ratio for the model. Compared with the fixed-mask sparse training, the state-of-the-art DST methods have shown superiority in accuracy and recently become a more broadly adopted sparse training paradigm.

However, although the existing sparse training approaches can reduce meaningful training costs, most of them devote their efforts to studying how to reduce training costs by further increasing sparsity while mitigating accuracy drop. As a result, conventional methods for improvement tend to focus on the sparse training performance at an extremely high sparsity ratio, e.g., 95% and 98%. Nevertheless, even the most recent sparse training approaches still lead to severe performance drop at these high sparsity ratios. For instance, on the Canadian Institute for Advanced Research, 10 classes (CIFAR-10) dataset, Memory-Economic Sparse Training (MEST) has a 2.5% and 4% accuracy drop at 95% and 98% sparsity, respectively. The CIFAR-10 dataset is a subset of the tiny images dataset and consists of 60000 32×32 color images. The network performance usually begins to drop dramatically at the extremely high sparsity, while the actual gains from weight sparsity, i.e., savings of computation and memory, tend to saturate. This indicates that reducing training costs by pushing sparsity towards extreme ratios at the cost of network performance is no longer a desirable methodology when a certain sparsity level has been reached.

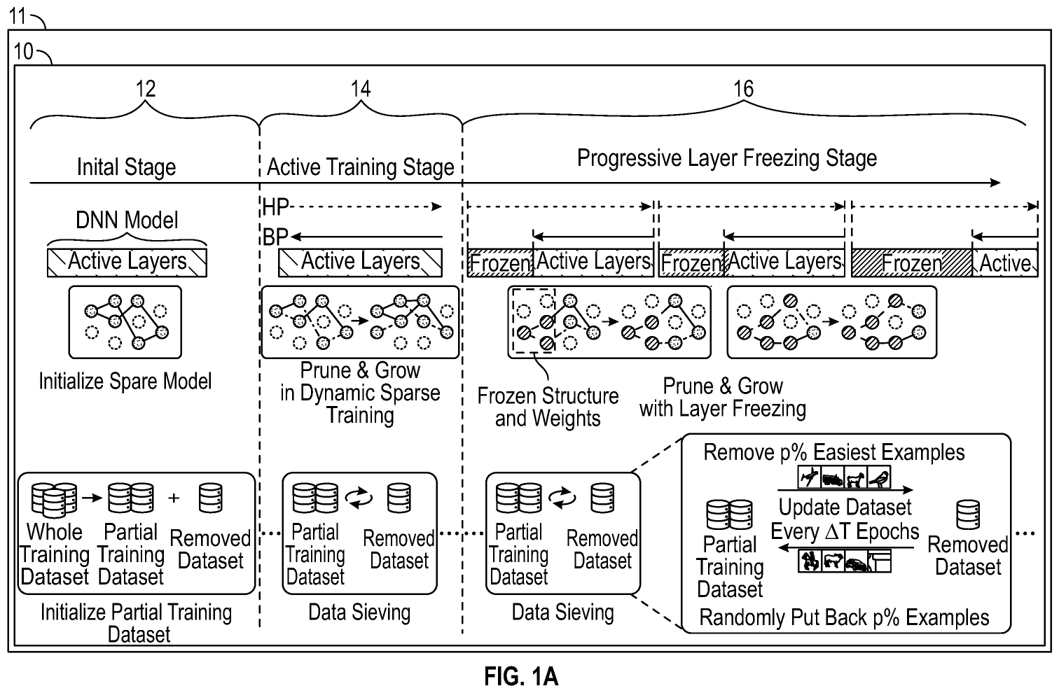

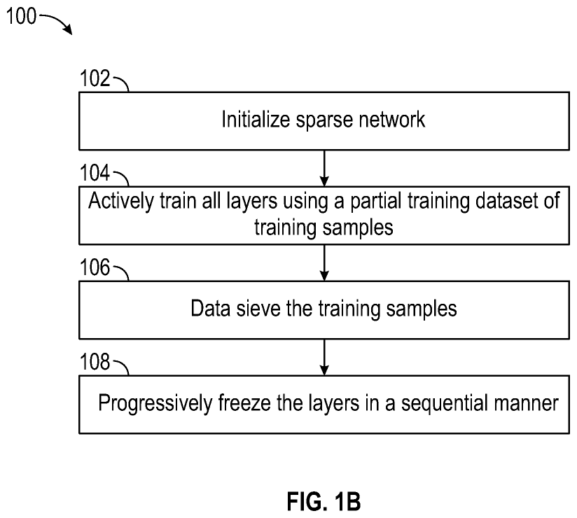

FIG. 1A is a diagram of an SpFDE framework 10 that is processed by an image processor 11 to train a sparse network (not shown) using a method 100 shown in FIG. 1B. The overall end-to-end training process is logically divided into three stages, including an initial stage 12, an active training stage 14, and a progressive layer freezing stage 16.

In the initial stage 12, the processor 11 initializes the sparse network and a partial training dataset at block 102. The structure of the sparse network is randomly selected. The partial training dataset is obtained by randomly removing a given percentage of training samples from the whole training dataset, which differs from prior work that starts with a whole training dataset. Only parts of the whole training dataset is used during the entire training process.

The active training stage 14 follows the initial stage 12, wherein all layers are actively trained (non-frozen) in block 104 by the processor 11 using a sparse training algorithm. In an example, Dynamic Sparse Training (DST) is applied from MEST as the sparse training method due to its superior performance, although other sparse training algorithms are compatible with the SpFDE framework 10.

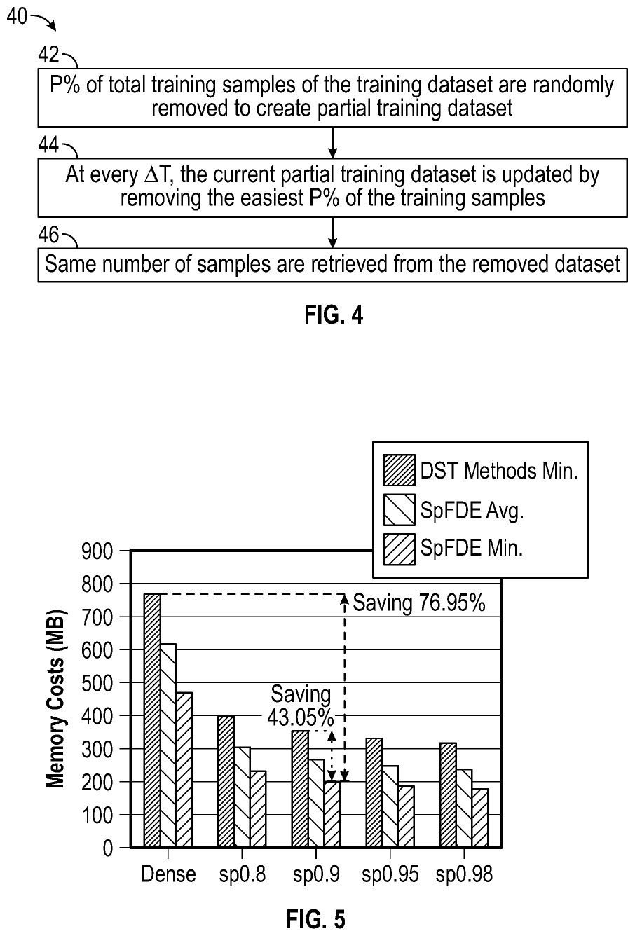

At block 106, a data sieving method is used by the processor 11 to update the current partial training dataset during the training (see FIG. 4). Besides the computation and memory savings provided by the sparse training algorithm, the SpFDE framework 10 benefits from the data sieving method to further save computation and memory costs. Specifically, the computation costs are reduced by decreasing the number of training iterations in each epoch, and the memory costs are reduced by loading the partial dataset.

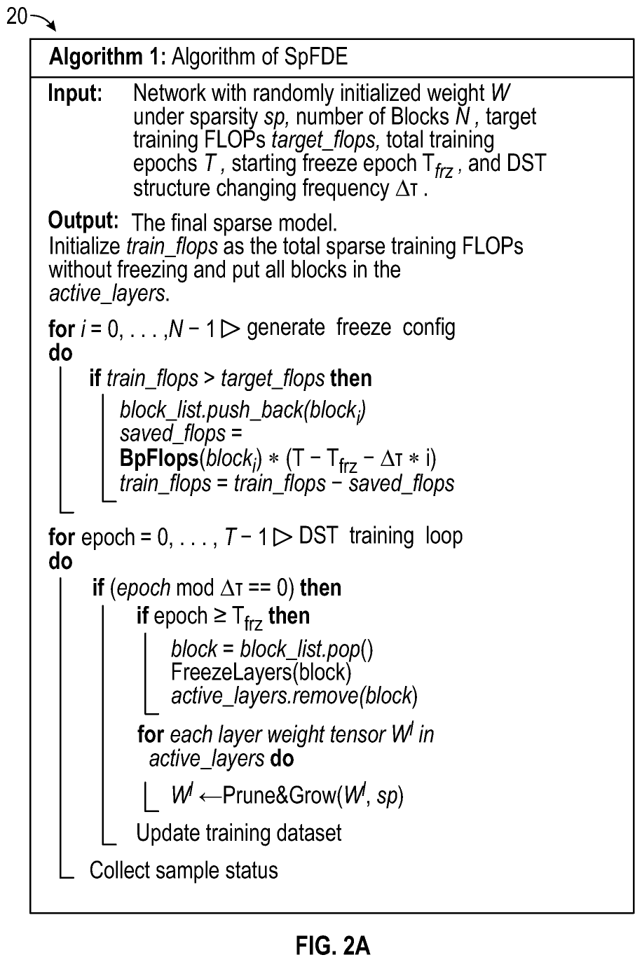

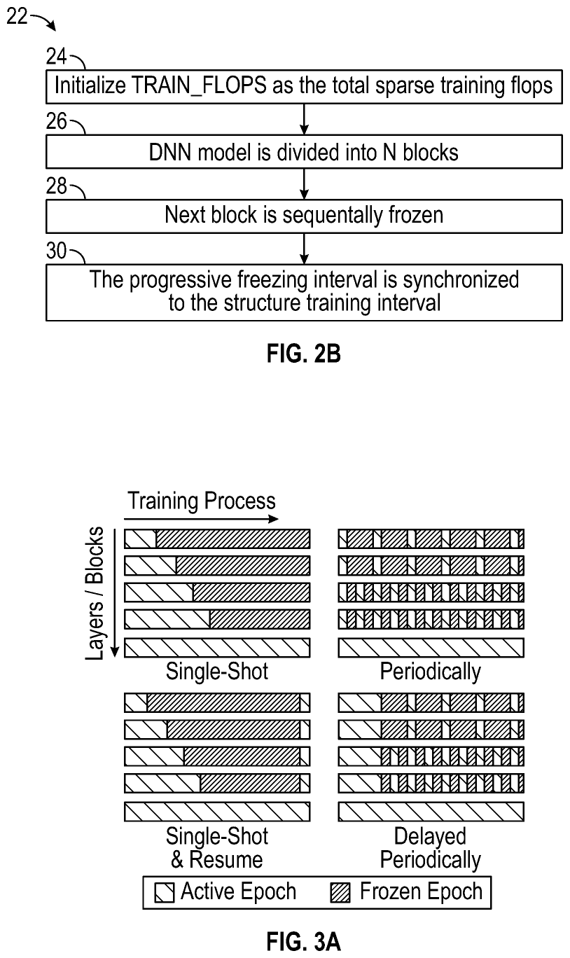

In the progressive layer freezing stage 16, the processor 11 progressively freezes the layers in a sequential manner at block 108 (see FIG. 2A). The sparse structure and weight values of the frozen layers remain unchanged during the sparse training. The computational and memory costs of all gradients of weights and gradients of activations in the frozen layers can be eliminated, which is useful for resource-limited edge devices.

Progressive Layer Freezing

Motivated by the observation that the structural and representational similarity of front layers converges faster than later layers in sparse training, the progressive layer freezing approach is used to gradually freeze layers sequentially. Specifically, a layer is frozen after all the layers in front of this layer are frozen. The progressive manner brings the benefits for maximizing the saving of training costs since the entire frozen part of the model does not require computing back-propagation.

Layer Freezing Algorithm

An algorithm 20 depicted in FIG. 2A is an example training flow of the SpFDE framework 10 using the progressive layer freezing algorithm. FIG. 2B illustrates a method 22 including the steps of the algorithm 20.

At block 24, train flops are initialized as the total sparse training FLOPs without freezing, and all blocks are put in the active_layers.

At block 26, for a given deep neural network (DNN) model with L layers, the DNN model is divided into N blocks, with each block N consisting of several consecutive DNN layers, such as a bottleneck block in a residual network (ResNet). A total training epoch is denoted T, Δτ as the sparse structure changing interval of dynamic sparse training, and T_{frz} (0<T_{frz}<T) as the epoch where the progressive layer freezing stage is started and freeze the first block.

At block 28, for every Δτ epochs, the next block is sequentially freezed until the expected overall training FLOPs satisfy the target_flops. The frozen blocks are considered to still need to conduct forward propagation during training. The training FLOPs reduction of freezing a block is computed as its sparse back-propagation computation FLOPs (calculated by BpFlops(⋅) in algorithm 20) multiplied by the total frozen epochs of the block.

At block 30, to better combine with the DST and ensure the layers/blocks are appropriately trained before being frozen, the progressive layer freezing interval is synchronized to the structure changing interval, i.e., Δτ, of the sparse training, and a layer/block-wise cosine learning rate schedule is adopted according to the total active training epoch of each layer/block.

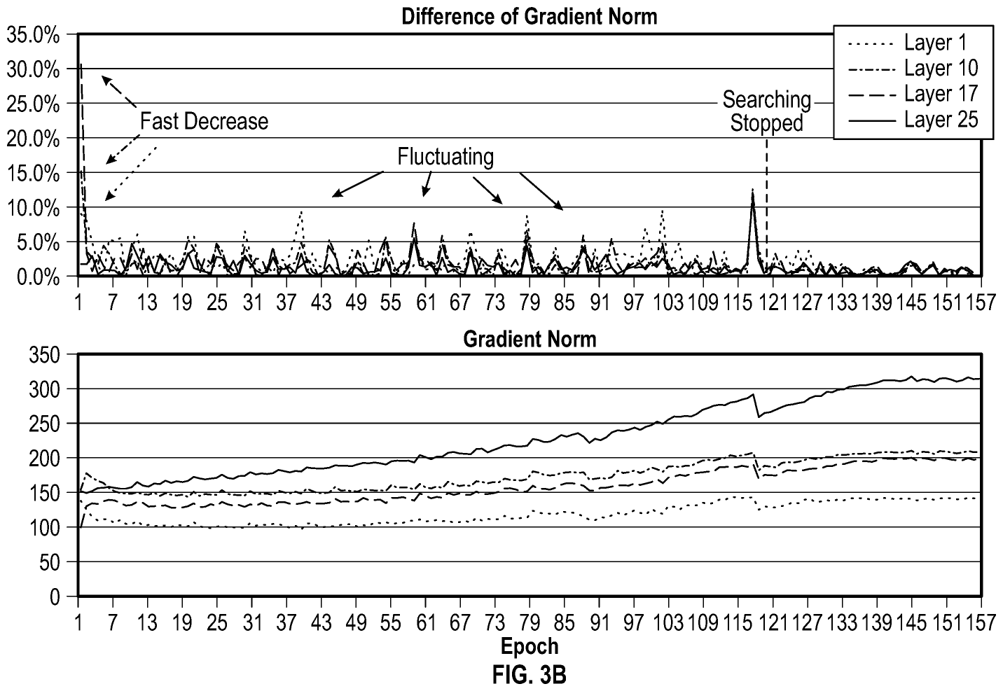

FIG. 3A illustrates different layer freezing schemes, and FIG. 3B illustrates a trend of layer gradient norm and the difference of layer gradient norm during dynamic sparse training.

Design Principles for Layer Freezing

There are two principles of focus for deriving the layer freezing algorithm 20, the freezing scheme and the freezing criterion.

Freezing Scheme

Since sparse training may target the resource-limited edge devices, it is desired to have the training method as simple as possible to reduce the system overhead and strictly meet the budget requirements. Therefore, a cost-saving-oriented freezing principle is followed to ensure the target training costs and derive the layer freezing scheme, which can include the single-shot, single-shot and resume, periodically freezing, and delayed periodically freezing, as illustrated in FIG. 3A. The single-shot scheme is adopted since it achieves the highest accuracy under the same training FLOPs saving, e.g., due to the single-shot freezing scheme having the longest active training epochs at the beginning of the training, which helps layers converge to a better sparse structure before freezing.

Freezing Criterion

Another question is how to derive the freezing criterion, i.e., choosing which iterations or epochs to freeze the layers. Conventional works have explored adaptive freezing methods by calculating and collecting the gradients during the fine-tuning of dense networks. However, the unique property of sparse training makes these approaches not applicable. For example, as shown in FIG. 3B, the difference of gradients norms from different layers decreases at the beginning of the sparse training while it keeps fluctuating after some epochs because of the prune-and-grow weights. Abstracting the freezing criterion based on the gradients norm would inevitably introduce extra computation and system complexity since the changing patterns of the gradient norm difference are volatile. Therefore, the SpFDE framework 10 combines the layer freezing interval with the DST interval which is more favorable.

Circular Data Sieving

With reference to FIG. 1A and FIG. 1B, a data sieving method 40 shown in FIG. 4 is used to achieve true dataset-efficient training throughout the sparse training process.

At block 42, at the beginning of the sparse training, a p % of total training samples of the training dataset are randomly removed to create a partial training dataset and a removed dataset.

At block 44, during the sparse training, for every Dr epoch, the current partial training dataset is updated by removing the easiest p % of the training sample from the partial training dataset and adding them to the removed dataset.

At block 46, the same number of samples are retrieved from the removed dataset and added back to the partial training dataset to keep the total number of training samples unchanged.

The number of forgetting times is adopted as the criteria to indicate the complexity of each training sample. Specifically, for each training sample, the number of forgetting times is collected by counting the number of transitions from being correctly classified to being misclassified within each Δτ interval. This number is re-collected for each interval to ensure the newly added samples can be treated equally. Additionally, the structure changing frequency Δτ is used in the sparse training as the dataset update frequency to minimize the impact of changed structure on the forgetting times.

The removed dataset is treated as a queue structure, retrieving samples from its head and adding the newly removed sample to its tail. After all the initial removed samples are retrieved, the removed dataset is shuffled after each update, making that all the training samples can be used at least once. As a result, the relatively easier samples are gradually sieved out and only the important samples are used for dataset-efficient training.

### Experimental Results

The SpFDE framework 10 is evaluated on benchmark datasets, including CIFAR-100 and ImageNet, for the image classification task with ResNet-32 and ResNet-50. ImageNet is an image database organized according to the WordNet® hierarchy (currently only the nouns), in which each node of the hierarchy is depicted by hundreds and thousands of images. WordNet® is a large lexical database of English. Nouns, verbs, adjectives, and adverbs are grouped into sets of cognitive synonyms (synsets), each expressing a distinct concept. The accuracy, training FLOPs, and memory costs of the SpFDE framework 10 are compared with the most representative parse training works at different sparsity ratios. Models are trained by using PyTorch on an 8×A100 graphics processing unit (GPU) server. PyTorch is an open source machine learning framework based on the Torch library, used for applications such as computer vision and natural language processing, primarily developed by Meta AI. Torch is a scientific computing framework with wide support for machine learning algorithms that puts GPUs first. A standard data augmentation and the momentum stochastic gradient descent (SGD) optimizer is adopted. A layer-wise cosine annealing learning rate schedule is used according to the frozen epochs. To make a fair comparison with the reference works, 160 training epochs are used on a CIFAR-100 dataset and 150 training epochs on the ImageNet dataset. ImageNet is an image database organized according to the WordNet® hierarchy (currently only the nouns), in which each node of the hierarchy is depicted by hundreds and thousands of images. MEST+EM&S is chosen as the training algorithm for weight sparsity since it does not involve any dense computations, making it desirable for edge device scenarios. Uniform unstructured sparsity is applied across all the convolutional layers while only keeping the first layer dense.

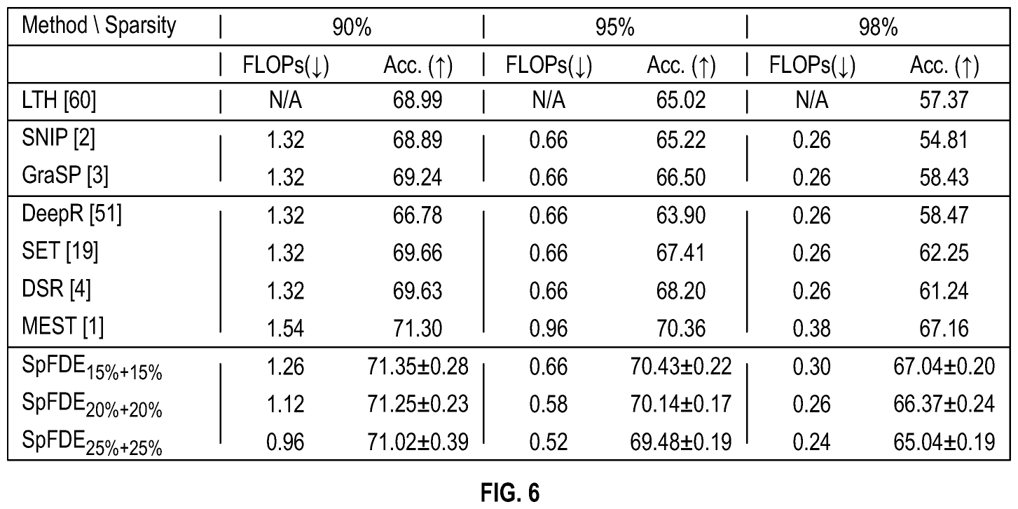

FIG. 6 shows the comparison of accuracy and computation FLOPs results on the CIFAR-100 dataset using ResNet-32. Each accuracy result is averaged over 3 runs. The configuration of SpFDE framework 10 is denoted using x %+y %, where x indicates the target training FLOPs reduction during layer freezing and y is the percentage of removed training data. The SpFDE framework 10 consistently achieves higher or similar accuracy compared to the most recent sparse training methods while considerably reducing the training FLOPs. Specifically, at 90% sparsity ratio, SpFDE_{20%+20%} maintains similar accuracy as MEST, while achieving 27% training FLOPs reduction. When compared with DeepR, SET, and DSR, SpFDE_{25%+25%} achieves 27% FLOPs reduction and +1.36%˜+4.24% higher accuracy. More importantly, when comparing SpFDE_{25%+25%} at 90% sparsity with the MEST at 95% sparsity, the two methods have the same training FLOPs, i.e., 0.96, while SpFDE_{25%+25%} has a clear higher accuracy, i.e., +0.66%. Reducing training costs by pushing sparsity towards extreme ratios is no longer a desirable methodology. The SpFDE framework 10 provides new dimensions to reduce the training costs while preserving accuracy.

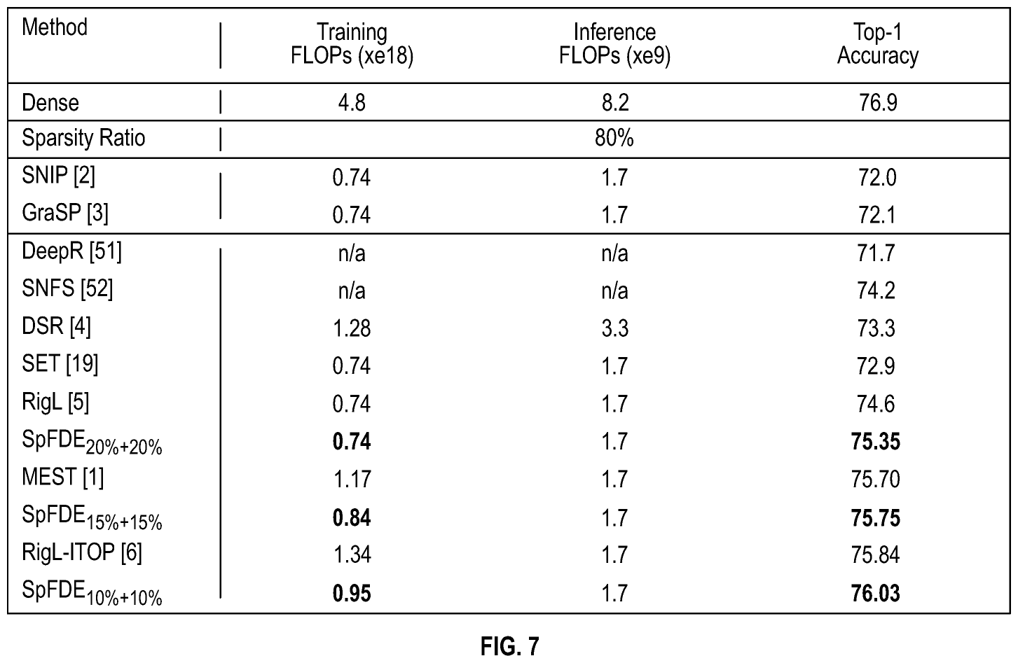

FIG. 7 provides comparison results on the ImageNet dataset using ResNet-50. At each training FLOPs level, the SpFDE framework 10 consistently achieves higher accuracy than existing works. Notably, the SpFDE framework 10 outperforms the original MEST, in both accuracy and FLOPs saving. The FLOPs saving is attributed to layer freezing and data sieving for end-to-end dataset-efficient training. Moreover, compared to the one-time dataset shrinking used in MEST, the data sieving dynamically updates the training dataset, mitigating over-fitting and resulting in higher accuracy.

Reduction on Memory Cost

Referring to FIG. 5, it can see the superior memory saving of the SpFDE framework 10. The memory costs indicate the memory footprint used during the sparse training process, including the weights, activations, and the gradient of weights and activations, using a 32-bit floating-point representation with a batch size of 64 on ResNet-32 using CIFAR-100. The “SpFDE Min.” stands for the training memory costs after all the target layers are frozen, while the “SpFDE Avg.” is the average memory costs throughout the entire training process. The baseline results of “DST methods Min.” only consider the minimum memory costs requirement for DST methods, which ignores the memory overhead such as the periodic dense back-propagation in RigL, dense sparse structure searching at initialization in, and the soft memory bound in MEST. Even under this condition, the “SpFDE Avg.” still outperforms the “DST methods Min.” with a large margin (20%˜25.3%). The “SpFDE Min.” results show minimum memory costs can be reduced by 42.2%˜43.9% compared to the “DST methods Min.” at different sparsity ratios. This significant reduction in memory costs is especially crucial to edge training.

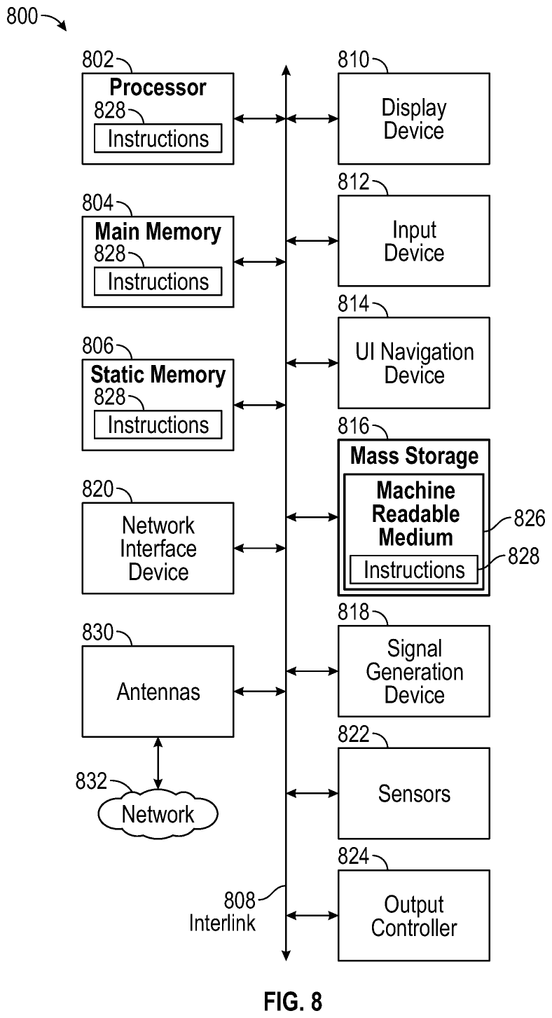

FIG. 8 illustrates a sample configuration of a computer system 800 adaptable to implement the framework described herein.

In particular, FIG. 8 illustrates a block diagram of an example of a machine 800 upon which one or more configurations may be implemented. In alternative configurations, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. In sample configurations, the machine 800 may be a personal computer (PC), a tablet PC, a set-top box (STB), a personal digital assistant (PDA), a mobile telephone, a smart phone, a web appliance, a server, a network router, switch or bridge, or any machine capable of executing instructions (sequential or otherwise) that specify actions to be taken by that machine. For example, machine 800 may serve as a workstation, a front-end server, or a back-end server of a communication system. Machine 800 may implement the methods described herein by running the software used to implement the features described herein. Further, while only a single machine 800 is illustrated, the term “machine” shall also be taken to include any collection of machines that individually or jointly execute a set (or multiple sets) of instructions to perform any one or more of the methodologies discussed herein.

Examples, as described herein, may include, or may operate on, processors, logic, or a number of components, modules, or mechanisms (herein “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. The software, when executed by the underlying hardware of the module, causes the hardware to perform the specified operations.

Accordingly, the term “module” is understood to encompass at least one of a tangible hardware or software entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810 (shown as a video display), an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a mass storage device (e.g., drive unit) 816, a signal generation device 818 (e.g., a speaker), a network interface device 820, and one or more sensors 822. Example sensors 822 include one or more of a global positioning system (GPS) sensor, compass, accelerometer, temperature, light, camera, video camera, sensors of physical states or positions, pressure sensors, fingerprint sensors, retina scanners, or other sensors. The machine 800 may include an output controller 824, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The mass storage device 816 may include a machine readable medium 826 on which is stored one or more sets of data structures or instructions 828 (e.g., software) embodying or utilized by any one or more of the techniques or functions described herein. The instructions 828 may also reside, completely or at least partially, within the main memory 804, within static memory 806, or within the hardware processor 802 during execution thereof by the machine 800. In an example, one or any combination of the hardware processor 802, the main memory 804, the static memory 806, or the mass storage device 816 may constitute machine readable media.

While the machine readable medium 826 is illustrated as a single medium, the term “machine readable medium” may include a single medium or multiple media (e.g., at least one of a centralized or distributed database, or associated caches and servers) configured to store the one or more instructions 828. The term “machine readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine readable medium examples may include solid-state memories, and optical and magnetic media. Specific examples of machine readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 828 may further be transmitted or received over communications network 832 using a transmission medium via the network interface device 820. The machine 800 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as WI-FI®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas 830 to connect to the communications network 832. In an example, the network interface device 820 may include a plurality of antennas 830 to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

The features and flow charts described herein can be embodied in one or more methods as method steps or in one or more applications as described previously. According to some configurations, an “application” or “applications” are program(s) that execute functions defined in the programs. Various programming languages can be employed to generate one or more of the applications, structured in a variety of manners, such as object-oriented programming languages (e.g., Objective-C, Java, or C++) or procedural programming languages (e.g., C or assembly language). In a specific example, a third party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating systems. In this example, the third party application can invoke API calls provided by the operating system to facilitate the functionality described herein. The applications can be stored in any type of computer readable medium or computer storage device and be executed by one or more general purpose computers. In addition, the methods and processes disclosed herein can alternatively be embodied in specialized computer hardware or an application specific integrated circuit (ASIC), field programmable gate array (FPGA) or a complex programmable logic device (CPLD).

Program aspects of the technology may be thought of as “products” or “articles of manufacture” typically in the form of at least one of executable code or associated data that is carried on or embodied in a type of machine readable medium. For example, programming code could include code for the touch sensor or other functions described herein. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from the server system or host computer of a service provider into the computer platforms of the smartwatch or other portable electronic devices. Thus, another type of media that may bear the programming, media content or metadata files includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to “non-transitory,” “tangible,” or “storage” media, terms such as computer or machine “readable medium” refer to any medium that participates in providing instructions or data to a processor for execution.

Hence, a machine readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read at least one of programming code or data. Many of these forms of computer readable media may be involved in carrying one or more sequences of one or more instructions to a processor for execution.

Unless otherwise stated, all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A framework for training a sparse network, the framework comprising a processor configured to:
initialize the sparse network, the sparse network having a sparse structure;
actively train all layers of the sparse network using a partial training dataset comprised of training samples;
data sieve the training samples to update the partial training dataset; and
progressively freeze the layers of the sparse network in a sequential manner to obtain a trained sparse network.

2. The framework of claim 1, wherein the processor is further configured to:
obtain the partial training dataset by randomly removing a percentage of training samples from a whole training dataset.

3. The framework of claim 1, wherein a layer is frozen only if all the layers in front of the layer are frozen.

4. The framework of claim 1, wherein the sparse structure and weight values of the frozen layers remain unchanged.

5. The framework of claim 4, wherein all gradients of weights and gradients of activations in the frozen layers are eliminated.

6. The framework of claim 1, wherein the data sieving decreases a number of training iterations in each epoch.

7. The framework of claim 1, wherein the data sieving comprises circular data sieving.

8. The framework of claim 7, wherein the circular data sieving comprises:
randomly selecting a percentage of total training samples of a training dataset to create the partial training dataset and a removed dataset;
updating the partial training dataset for every epoch by removing a number of the training samples from the partial training dataset and adding the removed training samples to the removed dataset; and
retrieving the same number of removed training samples from the removed dataset and adding the retrieved training samples back to the partial training dataset to keep the total number of training samples in the partial training dataset unchanged.

9. The framework of claim 1, wherein the processor is configured to actively train the layers by applying Dynamic Sparse Training (DST) from Memory-Economic Sparse Training (MEST).

10. The framework of claim 1, wherein the processor is configured to combine a layer freezing interval with a DST interval.

11. A method of using a framework having a processor configured to train a sparse network having a sparse structure, the method comprising:
initializing the sparse network;
actively training all layers of the sparse network using a partial training dataset comprised of training samples;
data sieving the training samples to update the partial training dataset; and
progressively freezing the layers of the sparse network in a sequential manner to obtain a trained sparse network.

12. The method of claim 11, further comprising:
obtaining the partial training dataset by randomly removing a percentage of training samples from a whole training dataset.

13. The method of claim 11, wherein a layer is frozen only if all the layers in front of the layer are frozen.

14. The method of claim 11, wherein the sparse structure and weight values of the frozen layers remain unchanged.

15. The method of claim 14, wherein all gradients of weights and gradients of activations in the frozen layers are eliminated.

16. The method of claim 11, wherein the data sieving decreases a number of training iterations in each epoch.

17. The method of claim 11, wherein the data sieving comprises circular data sieving.

18. A non-transitory computer readable medium storing program code, which when executed, is operative to cause a processor of a framework to train a sparse network having a sparse structure to perform the steps of:
initializing the sparse network;
actively training all layers of the sparse network using a partial training dataset comprised of training samples;
data sieving the training samples to update the partial training dataset; and
progressively freezing the layers of the sparse network in a sequential manner to obtain a trained sparse network.

19. The non-transitory computer readable medium of claim 18, wherein the code is operative to cause the processor to obtain the partial training dataset by randomly removing a percentage of training samples from a whole training dataset.

20. The non-transitory computer readable medium of claim 18, wherein the code is operative to cause the processor to freeze a layer only if all the layers in front of the layer are frozen.
